(19) United States
(12) Patent Application Publication
(10) Pub. No.: US 2004/0176139 A1
(43) Pub. Date: Sep. 9, 2004

(54) Method and wireless communication device using voice recognition for entering text characters

(75) Inventor: Stephen Huaiyuan Wang, Green Acres, FL (US)

Correspondence Address: Law Offices of David G. Posz, Suite 200, 2000 L Street, N.W., Washington, DC, 20036, US

(73) Assignee: MOTOROLA, INC.

(21) Appl. No.: 10/369,304

(22) Filed: Feb. 19, 2003

(51) Int. Cl. H04B 1/38; H04Q 7/20; H04M 1/00

(52) U.S. Cl. 455/563; 455/466; 455/550.1

(57) ABSTRACT

A method and apparatus to facilitate text message entry in a wireless communication device wherein a user interface is operated to place the wireless communication device in a text entry mode and a voice recognition circuit is used to process a spoken signal. The spoken signal is mapped to a corresponding text character or control character. The processor incorporates the text character or control character into a text message.

### FIELD OF THE INVENTION

This invention relates in general to wireless communication devices, and more specifically to a method and apparatus for entering text characters to be incorporated in a text message.

### BACKGROUND OF THE INVENTION

In many current wireless communication devices a method commonly used for entering alpha characters is commonly known as ‘triple tap.’ In this scheme a wireless communication device user may be required to press a single key multiple times to enter an alpha character (for example under the proper circumstances activating the “2” key three times results in a “C”).

On one cellular handset or telephone, for example, the number 1 key of the keypad is associated with the following characters: <space>1. @ / : ′ ? ! - _# * ″ $ % & +; = \ ( ) < > [ ]. To enter the character] requires 27 key presses of the number 1 key in this example. Many other characters including those special to non-U.S. English languages and foreign currencies are often associated in a similar manner with the same or other keypad keys.

This limits the speed, accuracy, and overall ease with which a user can enter text into a wireless communication device. Furthermore, it can be quite confusing when trying to determine which key is associated with a particular character. Other schemes of text entry on a wireless communication device exist other than ‘triple tap’, but exhibit the same characteristic defect. Clearly, a need exists for an improved method and apparatus for entering text characters on a wireless communication device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a representative form, a wireless communication device in accordance with the current invention.

FIG. 2 depicts, in a simplified and representative form, a block diagram of a wireless communication device in accordance with the current invention.

FIG. 3 depicts a process flow of a method for operation of a wireless communication device to capture text characters for incorporating into a text message.

### DETAILED DESCRIPTION OF PREFERRED EMBODIMENT

In overview, the present disclosure concerns wireless communication devices and apparatus and corresponding methods to facilitate selection of text characters and formation of text messages. The wireless communication devices of special interest are those with a limited keypad, such as cellular handsets or telephones available from a wide range of manufacturers. Because of the premium placed on size of the devices and the desire to be able to operate the unit with gloves and so on, the size and number of keys that may be included as part of the user interface for the device may be very limited. Other devices such as personal digital assistants that have essentially no keypad may also advantageously utilize the present invention. More particularly, various inventive concepts and principles embodied in methods and apparatus for the use of voice recognition as a method of selecting and entering text characters and other text-related tasks are discussed and described.

As further discussed below various inventive principles and combinations thereof are advantageously employed to allow a user of wireless communication device to more easily and accurately manage text entry processes than can be done with current communication devices. The text or textual messages may vary widely and include anything from a universal resource identifier (URL), phone book entries such as names and addresses, passwords, and the like typically associated with operation and management of the communications device as well as actual text messages that are intended to be communicated to other parties. Such messages would be typical of handsets that include short message services or SMS messaging, for example.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

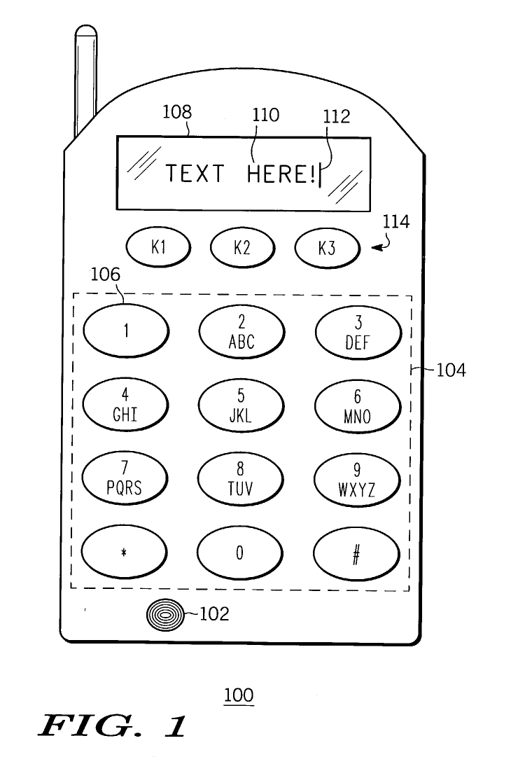

Referring to FIG. 1, an exemplary diagram of a wireless communication device 100 will be discussed and described. The wireless communication device 100 of FIG. 1 shows largely a user interface that includes a microphone 102 or opening in the housing of the device behind which is the microphone and an earpiece (not specifically depicted). The microphone 102 receives or picks up aural signals or sound waves caused by voiced utterances from a user and so on and converts them to electrical signals or a spoken signal representative of the voiced utterance. Also, depicted and included as part of the user interface is a more or less conventional keypad 104 including the 12 keys often found on telephones or cellular handsets. Note that certain of the keys are labeled with corresponding numbers and the alpha characters, such as ABC on the “2” key. Furthermore the “1” key 106 does not have any printed alpha characters and may be used for special functions or selecting characters such as punctuation or spaces in a text message.

In this example, a further element of the user interface is a display 108. The display 108 is a conventional display, such as a liquid crystal display or the like. In FIG. 1 the display 108 is depicted with the example text message “Text Here!” 110 and a vertical bar (1) 112. Note that the space and exclamation point (!) as well as the difference from upper to lower case for certain letters are not indicated or suggested by or on the keypad 104. The vertical bar 112 represents a text insertion point, or the point where the next character that is selected will be entered or incorporated into a text message. Often the vertical bar will be flashing to draw the attention of the user. The insertion point may be displayed or indicated in other manners, such as a flashing underscore or underlined display position and the like.

The wireless device or user interface for the device typically includes one or more other or additional keys, K1, K2, and K3, 114. These keys may be used for control of the device and include keys such as “send”, “end”, and “menu” for example. These keys 114, others on the keypad 104, or combinations of either may additionally be programmed or arranged for other tasks, for example, changing the wireless communication device 's functional mode. For instance, the keys may be used to enable or disable various modes of operation for the wireless communications device, such as a text entry mode of operation. As we will discuss further below voice recognition may be used to enable or disable various modes of operation as well as select text characters and control instructions.

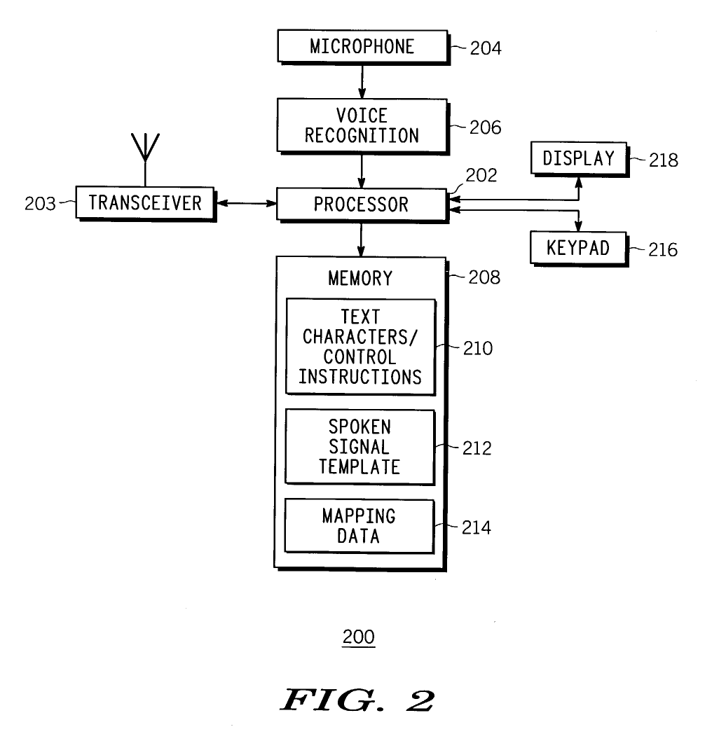

Referring to FIG. 2, a block diagram of a wireless communication device 200 that is arranged and constructed to facilitate text message entry will be discussed and described. An exemplary apparatus and method of selecting text characters using voice recognition of a corresponding spoken signal is described. The wireless communication device includes a processor 202 that is known and typically comprised of a one or more microprocessors and digital signal processors available from various manufacturers such as Motorola. The processor 202 is coupled to and controls a transceiver 203 that operates as controlled by the processor to receive and transmit various messages, including control messages and traffic messages such as voice messages or text messages.

The processor is further coupled to a user interface including a microphone 204 through a voice recognition circuit, unit, or processor 206. The voice recognition unit is known and comprised typically of one or more digital signal processors that process a signal or spoken signal corresponding to sound waves as received by the microphone 204. The processor is further coupled to other elements of the user interface, specifically a keypad 216 and display 218. Note that the microphone, keypad, and display are similar to and operate analogously to those elements as discussed above with reference to FIG. 1.

The processor 202 is shown coupled to a memory 208. The memory in addition to including object code, not specifically depicted, that is executed by the processor to perform general control of the wireless communications unit as well as display and keypad interface routines, includes various databases including a text characters and control instructions 210, spoken signal templates 212, and mapping data 214 data bases. Note the memory is also common to the voice recognition unit and may store object code for execution by the voice recognition processors. The voice recognition unit 206 will compare the results of processing a spoken signal with the spoken signal templates 212. When a match is found the processor 202 or voice recognition unit or processor 206 may use the mapping data 214 to cross reference a text character or control character 210.

In more detail, the wireless communication unit 200 facilitates text message entry as follows. Initially the user interface is used and operable to enable a text entry mode. The device may be placed in a text entry mode for one of several reasons and by one or several methods. For example activation of one of the keys or a combination of the keys such as a menu key followed by selection of a text entry mode of operation could be used or some other so called soft key may be used to enable the text entry mode. Reasons for entering the text entry mode include, for example, creation of a short message service (SMS) text message as an originator of such a message or in response to a received text message. Other reasons include the need to enter a password as required by one or more wireless communication device services, creating or editing a phone book entry, or entering a Universal Resource Locator (URL) for web browsing or perhaps a voiced command.

A voiced utterance from a user is received by the microphone 204 and converted to a spoken signal or an electrical representation of the voiced utterance. The spoken signal is passed to the voice recognition circuit 206 where the spoken signal is processed according to known voice recognition techniques. Such voice recognition techniques are available in cellular handsets available from various manufacturers and these techniques may be converted given the concepts and principles disclosed herein to the purposes herein. The spoken signal as processed will then be mapped to a text character corresponding to the spoken signal. The mapping may be done by the voice recognition circuit 206 in whole or in part. Alternatively, the characteristics of the spoken signal, as determined by the processing undertaken by the voice recognition unit 206, can be passed to the processor 202 where they may be further analyzed for structure and content. Typically the voice recognition unit 206 will match the spoken signal to a template stored in the memory 212 and when a match is found it will be mapped using the mapping data 214 to one of the text characters or control characters 210. The voice recognition unit 206 or the processor 202 may do the mapping. In any event, the processor 202 will be operable to incorporate the text character into a text message or manipulate the text message according to a control character.

It is envisioned that either speaker independent or speaker dependent means for voice recognition could be used. If speaker independent voice recognition is used then a set of voice recognition templates would be pre-programmed into the memory space 212. If speaker dependent voice recognition techniques are used the voice recognition templates would need to be developed and programmed into the memory by one or more users of the wireless communication device.

In more detail, the memory 208 contains a multiplicity of voice recognition templates 212, each of which is a collection of properties that are expected to be found when a corresponding spoken signal is processed by the voice recognition circuitry or unit. These spoken signal templates 212 are used for comparison with the spoken signals as processed that are provided by the voice recognition block 206. When the voice recognition unit or the processor 202 finds a satisfactory match between the actual spoken signal or specifically the results of processing the spoken signal and one of the voice recognition templates the match is cross referenced by the mapping information or data 214. The mapping data 214 defines a relationship between the spoken signal and one text character or control character of the multiplicity of possible text characters or control character stored in memory 210. The result of this mapping process will be a character, for example, a pointer to a text character or graphical representation thereof which is then used by processor 202 to incorporate into or otherwise manipulate a text message, for example to place or display the text character on the display 218 at an insertion point 110. Thus, the display that is coupled and responsive to the processor is used to display the text character at an insertion point in the text message, responsive to the spoken signal being mapped to the text character

It is feasible in some embodiments of the wireless communication device that the text characters and the resulting text message may not be displayed, but kept only in memory. Such an embodiment may arise with a wireless communication device that is for the visually impaired or as a cost saving measure that does not incorporate a display into the wireless communication device.

The keypad 216 comprises a plurality of keys such as depicted in FIG. 1. Any of the keys, such as key 106 in FIG. 1, may correspond or be programmed to correspond to any of a multiplicity of text characters. For example, the “1” key may correspond to ten or more control or punctuation characters on some communications devices. The text characters or substantial portions thereof so programmed are typically not printed or otherwise indicated on the physical key 106 and any one key will usually correspond to only a portion of the full set of text or control characters that may be recognized via the voice recognition unit or are supported by the wireless communication device. The key 106 is pressed to activate a first text character and succeeding presses of the key activate or select additional characters. The key 106 would be used to enter the text characters which are printed on the key and also additional text characters such as non-English language characters and punctuation symbols. The keypad 216 as noted above could be, for example, a numeric keypad for a telephone or a cellular phone and the key 106 one of the numeric keys.

It is desirable, but not necessary, to have both the keypad 216 and voice recognition circuit 206 active at the same time. Thus the user will have a choice of methods for entering text interactively, for example, using the keypad 216 for the text characters that are printed on the keys and spoken signals via the voice recognition circuit 206 for punctuation. The processor is operable to incorporate text characters or control characters from either the keypad or the voice recognition circuit into the text message.

An additional embodiment extends the use of the spoken signals to represent not only visible text characters but non-printing characters or control instructions that can alter the shape of characters, such as bold, italic, upper case, lower case and the placement of characters such as moving the text character insertion point cursor left and right. Entry of these control instructions would follow the same process as other spoken signals with the mapping data 214 referencing a control instruction instead of a text character in memory 210. A text message may be created and manipulated to a desired result by a combination of control instructions and text character insertions.

It is likely that the voice recognition circuit 206 and processor 202 may be capable of mapping spoken signals corresponding to more than text characters or control instructions, for example voice dialing spoken signals. When the wireless communication device is placed in a text entry mode it may be useful for the voice recognition circuit 206 and processor 202 to limit their matching of spoken signals to those text characters and control instructions mapped for text entry purposes. Similarly, all possible text characters in memory 210 supported by voice recognition 206 may not be required in every text entry mode supported, so in a given text entry mode it may be expedient that only the subset required for that text entry mode would be active. For example, if the text entry is used to enter a numeric Personal Identification Number (PIN), only numeric spoken signals would be enabled. This would speed the matching process and reduce the burden on the voice recognition circuit 206 and processor 202. Thus, the voice recognition circuit, processor, or unit may be enabled only for specific purposes and this can be accomplished via a predetermined key activation or predetermined voiced command. The voice recognition processes may only be enabled to select a given character corresponding to a given key or set of keys or as noted only for recognizing numeric characters.

In summary, we have discussed an apparatus to facilitate text message entry for a wireless communication device. This apparatus comprises a user interface preferably comprising a numeric keypad and a microphone operable to enable a text entry mode for the wireless communication device and provide a spoken signal. Further included is the voice recognition circuit that is operable to process the spoken signal, and map the spoken signal to one of a control instruction and a text character corresponding to the spoken signal. Additionally a processor is coupled to the user interface and the voice recognition circuit and is operable to manage text message formation by, for example, insertion of the text character into a text message or manipulation of the text message in accordance with the control instruction.

The control instruction may be a cursor movement instruction or the control instruction may alter the shape or format or other characteristics of a displayed text character. The display is coupled and responsive to the processor to display the text character at an insertion point in the text message responsive to the spoken signal being mapped to the text character. The processor, for example, may manipulate the insertion point in the text message, responsive to the spoken signal being mapped to the control instruction. The voice recognition circuit or processor may be enabled for one of speaker independent voice recognition of the spoken signal and speaker dependent voice recognition of the spoken signal.

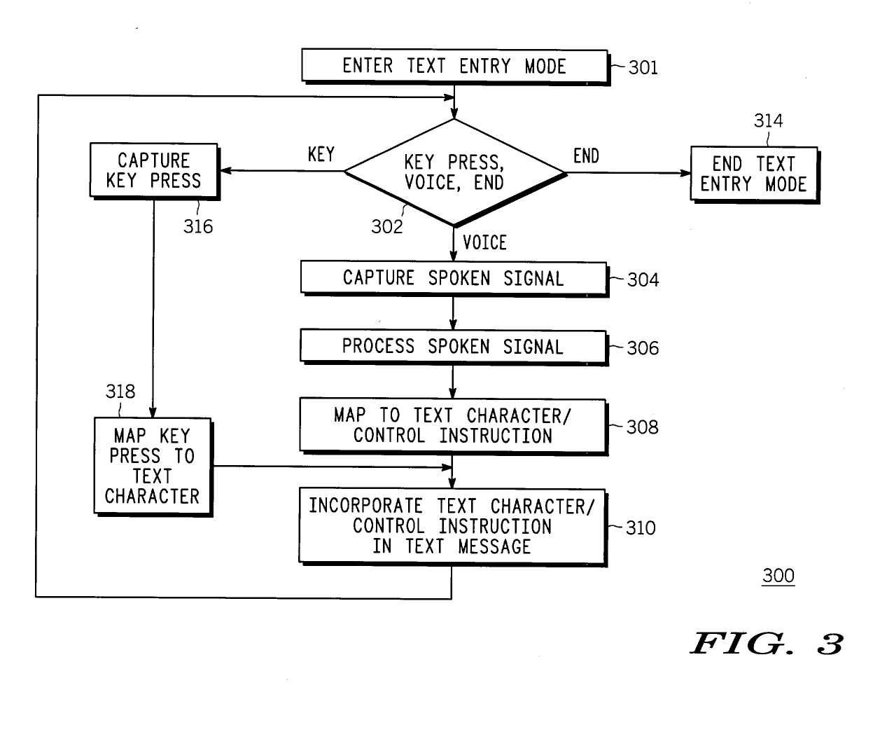

Referring to FIG. 3, a method 300 or a process flow for entering text characters as an element of a text message in wireless communication device will be discussed and described. Many of the concepts and principles embodied by the method of FIG. 3 have been discussed and described above so this description will be more of an overview of the method. As earlier noted the wireless communication device 200 or relevant portion thereof is placed into or enabled or enters a text entry mode 301 by various means and for various reasons or purposes. Such purposes include, but are not limited to, creation of an original SMS text message, or a reply to a received text message, a prompt for a password to access one or more wireless communication device services, creating or editing a phone book entry, entering a Universal Resource Locator for web browsing, a voiced command or the like. The method waits or tests at 302 for input from the keypad 216 or preferably enabling of the voice recognition circuit 206 or an end of the text message mode of operation via for example time out of the text entry mode.

If the voice recognition unit is enabled as detected at 302, the flow follows the Voice branch from 302 to 304 where a voiced utterance is detected by a microphone 204 and the spoken signal is captured. At 306, the spoken signal is processed in the voice recognition circuit and possibly in conjunction with the processor and at 308 the spoken signal, as processed, is mapped to a text character or control instruction that is one of a multiplicity of text characters or control instructions. The control instruction may for example be a cursor movement or text character presentation format. Following the mapping at 308 the method proceeds to 310 where the selected text character is incorporated as an element of a text message on the display 218 at the text insertion cursor position 110 or the control instruction is executed. A control instruction would also operate at the current text insertion position 110 to move the cursor or change the presentation, for example to a bold font. The method then returns to 302.

If an action on the wireless communication device ends the text entry, for example pressing a soft key 112 programmed as a send key, the End path from 302 is taken and the text entry mode is exited at 314. If no action is taken to end text entry, monitoring for a key press or spoken signal is continued at 302. When a key press is detected, the Key path from 302 is taken. The key press or activation is captured at 316 and the key press is mapped to a text character from a multiplicity of text characters at 318. The method proceeds to 310 and the text character is incorporated as an element of a text message on the display 218 at the text insertion cursor position 110. The method returns to 302.

The processes, apparatus, and systems, discussed above, and the inventive principles thereof are intended to and are expected to alleviate problems caused by current text character entry methods, particularly on wireless communications devices with limited keypads. Using this principle of supplementing or replacing wireless communication device text capture by voice recognition of spoken signals will greatly simplify and enhance the user experience of wireless communication devices.

Various embodiments of methods and apparatus for a wireless communication device in a text entry mode to capture text characters have been discussed and described. It is expected that these embodiments or others in accordance with the present invention will have application to virtually all wireless communication devices that incorporate text character entry. The disclosure extends to the constituent elements or equipment comprising such devices and specifically the methods employed thereby and therein.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A wireless communication device arranged and constructed to facilitate text message entry comprising:
a user interface operable to enable a text entry mode;
a voice recognition circuit operable to process a spoken signal and map the spoken signal to a text character corresponding to the spoken signal; and
a processor coupled to the user interface and the voice recognition circuit, operable to incorporate the text character into a text message.

2. The wireless communication device of claim 1 further comprising:
a display coupled and responsive to the processor to display the text character at an insertion point in the text message responsive to the spoken signal being mapped to the text character.

3. The wireless communication device of claim 1 wherein the user interface further comprises:
a keypad coupled to the processor, the keypad including a key corresponding to any one of a multiplicity of text characters; and
wherein the processor is operable to incorporate text characters from either of the keypad and the voice recognition circuit into the text message.

4. The wireless communication device of claim 3 wherein the key corresponds to text characters that are not indicated on the key.

5. The wireless communication device of claim 3 wherein the keypad comprises a numeric keypad for a telephone and the key is a numeric key.

6. The wireless communication device of claim 3 wherein the wireless communication device supports a set of text characters, the multiplicity of text characters being a portion of the set, wherein activation of the key enables the voice recognition circuit to select the text character from the portion.

7. The wireless communication device of claim 1 wherein the voice recognition circuit is arranged to recognize any one of a set of spoken signals and the text entry mode enables voice recognition of the spoken signal.

8. The wireless communication device of claim 1 wherein the text message is one of a Universal Resource Locator, a phone book entry, a password and a query response.

9. The wireless communication device of claim 1 further comprising:
a memory coupled to the processor for storing data associated with the spoken signal, text characters, and information for mapping the spoken signal to the text character corresponding to the spoken signal.

10. The wireless communication device of claim 1 wherein a voice recognition template is pre-programmed and the voice recognition circuit provides speaker independent recognition of the spoken signal.

11. The wireless communication device of claim 1 wherein a voice recognition template corresponding to a user is programmed and the voice recognition circuit provides speaker dependent recognition of the spoken signal.

12. The wireless communication device of claim 1 wherein the user interface includes a key that when activated enables the text entry mode and a microphone to convert a voiced utterance to the spoken signal.

13. The wireless communication device of claim 12 wherein the voice recognition circuit in enabled by one of a voiced command and a key activation.

14. An apparatus to facilitate text message entry for a wireless communication device comprising:
a user interface comprising a numeric keypad and a microphone operable to enable a text entry mode for the wireless communication device;
a voice recognition circuit operable to process a spoken signal, and map the spoken signal to one of a control instruction and a text character corresponding to the spoken signal; and
a processor coupled to the user interface and the voice recognition circuit, operable to manage text message formation by one of insertion of the text character into a text message and manipulation of the text message in accordance with the control instruction.

15. The apparatus of claim 14 wherein the control instruction is a cursor movement instruction.

16. The apparatus of claim 14 wherein the control instruction alters the shape of a displayed text character.

17. The apparatus of claim 14 further comprising:
a display coupled and responsive to the processor to display the text character at an insertion point in the text message responsive to the spoken signal being mapped to the text character.

18. The apparatus of claim 17 wherein:
the processor manipulates the insertion point in the text message, responsive to the spoken signal being mapped to the control instruction.

19. The apparatus of claim 14 wherein the voice recognition circuit is enabled for one of speaker independent voice recognition of the spoken signal and speaker dependent voice recognition of the spoken signal.

20. A method in a wireless communication device for entering a text character as an element of a text message comprising:
activating a text entry mode;
capturing a spoken signal;
processing the spoken signal using voice recognition to map the spoken signal to a text character selected from a multiplicity of text characters; and
incorporating the text character as an element of a text message.

21. The method of claim 20 further comprising the steps of:
detecting a key press on a keypad; and
mapping the key press to an other text character selected from the multiplicity of text characters; and
incorporating the other text character as an element of the text message.

22. The method of claim 20 wherein the activating step further comprises:
enabling the voice recognition of the text character where the multiplicity of text characters is a portion of a set of text characters that can be selected by the voice recognition.

23. The method of claim 20 wherein the activating the text entry mode is initiated by one of a voiced command and a key activation.

24. The method of claim 20 further including:
displaying the text character as the element of the text message.
